(19) United States
(12) Patent Application Publication
(10) Pub. No.: US 2009/0040875 A1
(43) Pub. Date: Feb. 12, 2009

(54) METHOD AND SYSTEM FOR SYNCHRONIZATION AND DISPLAY OF A PLURALITY OF CALENDARS ON A DEVICE

(75) Inventors: Adrian Buzescu, Bellevue, WA (US); Cristian Serban, Bellevue, WA (US)

Correspondence Address: KENYON & KENYON LLP, ONE BROADWAY, NEW YORK, NY, 10004, US

(73) Assignee: T-MOBILE USA, INC., Bellevue, WA (US)

(21) Appl. No.: 12/188,088

(22) Filed: Aug. 7, 2008

Related U.S. Application Data
(60) Provisional application No. 60/964,268, filed on Aug. 9, 2007.

(51) Int. Cl. G04C 11/00; G04C 17/00

(52) U.S. Cl. 368/29; 368/46

(57) ABSTRACT

A method and system are provided for synchronizing a plurality of calendars on a mobile device. An embodiment includes responsive to receiving a plurality of event objects, parsing each event object into event information and a calendar identifier. The method includes associating each event object with a calendar based on the calendar identifier. The method includes displaying the event objects on a calendar client executing on the consumer device, wherein each event object indicates the calendar with which it is associated.

### CROSS-REFERENCE TO RELATES APPLICATIONS

This application claims priority to U.S. Provisional Patent Application No. 60/964,268, filed Aug. 9, 2007, entitled “Method and System for Synchronization and Display of a Plurality of Calendars on a Mobile Device,” which is herein incorporated by reference in its entirety.

### COPYRIGHT AND LEGAL NOTICES

A portion of the disclosure of this patent document may contain material which is subject to copyright protection. The copyright owner has no objection to the facsimile reproduction by anyone of the patent document or the patent disclosure, as it appears in the Patent and Trademark Office patent files or records, but otherwise reserves all copyrights whatsoever.

### FIELD OF INVENTION

The present invention relates to a system and a method for synchronization and display of a plurality of calendars on a mobile device.

### BACKGROUND INFORMATION

Personal calendar applications that keep track of events and tasks are generally available. Each event or task may be stored as an event object and include a variety of metadata, such as start time, end time, and description. Such calendars may be available on a user's personal computer, a mobile device, a personal digital assistant, or online as a web application.

Event objects may be stored in a standard format, such as vCalendar (“vCal”) or iCalendar (“iCal”). vCal is an older standard exchange format for calendar data promulgated by the Internet Mail Consortium. iCal is a newer standard (RFC 2445, incorporated herein by reference) for calendar data, apparently based on vCal. iCal allows users to send and receive meeting requests to other users through email.

Mobile devices, such as cellular phones, may execute calendar clients that provide a calendar feature to a user. The user may add event objects to be stored on the cellular phone, and modify or delete existing event objects.

The calendar client executing on a mobile device may also synchronize with a server. The server may store the event objects associated with a user's calendar, which are transmitted to the mobile device. The server also provides web access to the calendar to the user. The mobile device and the server may synchronize over a wireless network.

However, the above technologies do not support synchronizing more than one calendar to a mobile or consumer device. Thus, there exists a need to synchronize events from multiple calendars to a mobile device for display to a user, where events from different calendars may be distinguishable from each other. There also exists a need to synchronize events from multiple calendars on a consumer device which implements a client calendar application and communicates with a back-end server or network using available protocols, e.g., SyncML.

### BRIEF DESCRIPTION OF THE DRAWINGS

FIG. 1 shows an example screen shot of a day view of a calendar client on a mobile device displaying events from multiple calendars in accordance with an embodiment of the present invention.

FIG. 2 shows an example screen shot of a calendar list in a calendar client on a mobile device in accordance with an embodiment of the present invention.

FIG. 3 shows an example screen shot of a reminder of an event of a specific calendar in a calendar client on a mobile device in accordance with an embodiment of the present invention.

FIG. 4 shows an example system for synchronizing multiple calendars with a mobile device in accordance with an embodiment of the present invention.

FIG. 5A shows an example procedure for synchronizing multiple calendars with a mobile device and displaying that to the end user in accordance with an embodiment of the present invention.

FIG. 5B shows an example procedure for synchronizing multiple calendars to a mobile device in accordance with an embodiment of the present invention.

FIG. 6 shows example data fields to allow synchronizing multiple calendars with a mobile device in accordance with an embodiment of the present invention.

### DETAILED DESCRIPTION

Embodiments of the present invention provide a method and system which synchronize a plurality of calendars stored on one or more back-end repositories with a calendar client executing on a mobile device or other consumer device. Each calendar may include one or more events, each event being stored as an event object associated with at least a date/time and a text description. The mobile device may be a user's mobile handset such as a cellular phone, a personal data assistant having mobile communications capability or network access, or other device.

Embodiments of the present invention allows the mobile device to display events from multiple calendars, wherein each event may be differentiated from each other, e.g., color-coded, bolded, highlighted, etc., according to the event's associated calendar. Synchronization between the back-end repositories and the mobile device may be preformed using an Open Mobile Alliance (“OMA”)-defined SyncML DS protocol. Events are stored as vCal/iCal objects with non-standard properties to indicate the originating calendar associated with each event.

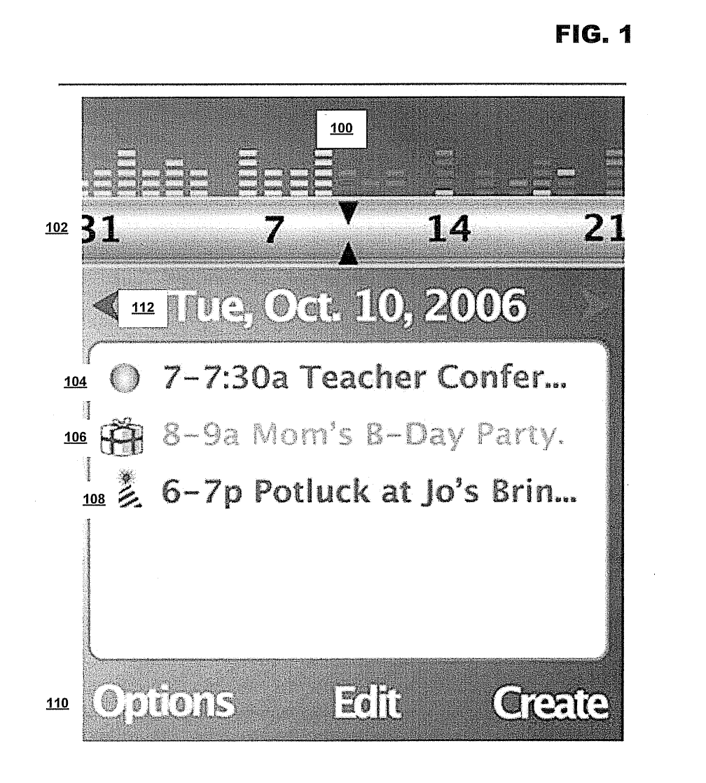

FIG. 1 shows an example screen shot of a day view of a calendar client on a mobile device displaying events from multiple calendars in accordance with an embodiment of the present invention. The screen shot may be displayed on a mobile device, for example, a cellular phone, personal digital assistant, and/or a Wi-Fi telephone system, to a user.

The screen shot includes calendar overview 100, which displays upcoming events and differentiates the upcoming events according to their associated calendar using color-coding. For example, for a specific day it may show blocks of colors representing events from different calendars occurring in the same day.

The screen shot includes date selector 102, which displays a currently selected date and a time period before and after the selected date. For example, the user may scroll forward and back to select another date.

The screen shot includes events 104, 106, and 108. The events 104, 106, and 108 may be stored as event objects on the mobile device and synchronized with a server over a wireless network as discussed later. The event objects may be stored as vCal and/or iCal objects on the mobile device and on the server.

The events 104, 106, and 108 may each be color-coded according to its associated calendar. The events 104, 106, and 108 may each be associated with a special icon, such as a circle indicating a work event, a birthday present indicating a birthday party, and/or a party hat indicating a party event.

It will be appreciated that any number of special icons and calendar colors and/or other differentiators may be provided, either user-selected or programmer-selected or randomly-selected/generated.

In FIG. 1, the screen shot is shown having a tool bar 110, which displays available tools in the calendar client. For example, tools may include opening an options menu, editing a selected event, or creating a new event.

It will be appreciated that other menus or tools may also be provided on the tool bar.

The screen shot includes a date indicator 112, which displays the current date. For example, the date indicator 112 may display the current date in a user-selected format.

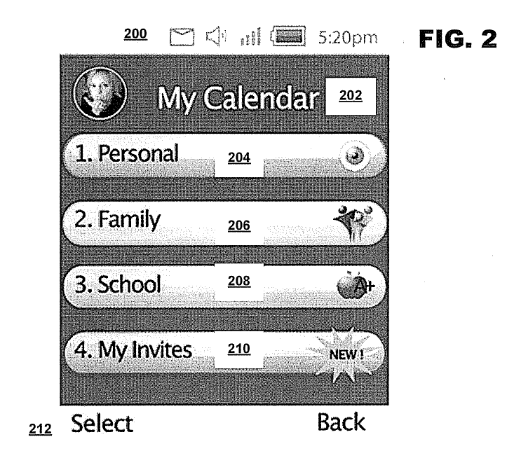

FIG. 2 shows an example screen shot of a calendar list in a calendar client on a mobile device in accordance with an embodiment of the present invention. The calendar list screen may be displayed to the user and receive a user selection of calendars to display. For example, the user may select only personal and school calendar events to be displayed in the calendar client.

A status bar 200 may display icons indicating the status of the mobile device. For example, status indicators may include a text message indicator, a voicemail indicator, a mobile device volume indicator, a signal strength indicator, a battery indicator, and a current time. It will be appreciated that other indicators and icons may be displayed on the status bar 200.

A title and icon 202 may be displayed. The icon may be, for example, a personal picture, a user-selected graphic, a randomly-generated graphic or text or combination of graphic and text, or an automatically-generated graphic.

A plurality of calendars 204, 206, 208, and 210 may be displayed. The user may select one or more calendars to be displayed, resulting in only events associated with the selected calendars displayed in the calendar client. For example, the calendar client may be as depicted in FIG. 1.

A user may create a new calendar by entering calendar metadata. The new calendar may be synchronized with a server over a wireless network.

Calendars may be visible to third parties. Each of calendars 204, 206, 208, and 210 may be private, semi-private, or public. A private calendar is only visible to the user, either on the mobile device, through a web-interface provided by a server, or some other interface. For example, a personal calendar may be set as private. A semi-private calendar is visible to a set of users. For example, a family may create a family calendar with family events, accessible only to members of the family. For example, a public calendar may be made visible to any user. For example, a school may create a school calendar with school events, accessible to any interested user.

The color-coding scheme provided by associating each event object with a calendar identifier easily allows the user to intuitively and quickly recognize which events displayed on a calendar client belong to what calendar.

A tool bar 212 may be displayed, which displays available tools in the current screen. For example, tools may include selecting a calendar or going back to a previous screen.

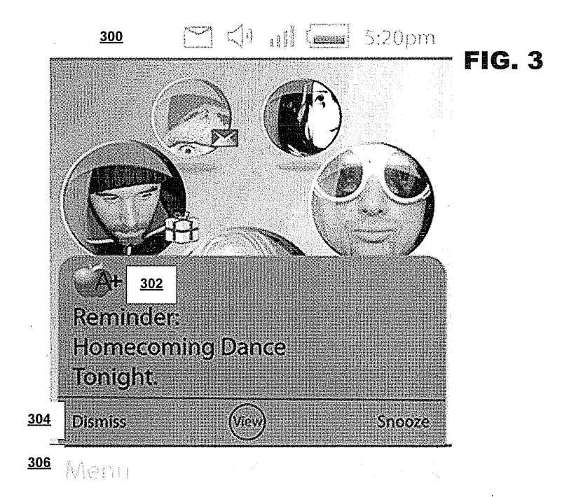

FIG. 3 shows an example screen shot of a reminder in a calendar client on a mobile device in accordance with an embodiment of the present invention. The calendar client may be in background mode with a screen saver active on the mobile device's display. A reminder may pop up on the mobile device's display at a predetermined time from the beginning of an event. For example, the reminder time may be user-selected.

A mobile device screen shot 300 may include a status bar, as discussed above, and a background graphic.

A reminder 302 may be color-coded according to its associated calendar, as discussed above. The reminder 302 may include a description of the event.

A reminder tool bar 304 may be displayed, which displays available tools in the reminder. For example, the reminder may be dismissed, the event may be viewed, or a snooze feature may be activated. If a snooze feature is activated, the reminder may pop up again in a predetermined amount of time.

A phone tool bar 306 may be grayed out when the reminder pops up. The phone tool bar 306 may display available tools in the phone's main display. For example, the user may select to view a menu of available tools or to view the phone book of stored contacts. The phone tool bar 306 may resume functioning after the reminder pop-up has been closed, either by being dismissed or snoozed.

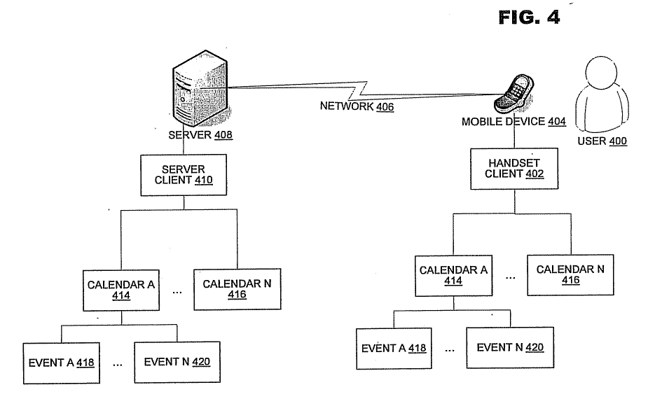

FIG. 4 shows an example system for synchronizing multiple calendars with a mobile device in accordance with an embodiment of the present invention.

A user 400 may access a calendar client 402. The calendar client 402 may display events to the user and allow the user to add, modify, or delete events. The calendar client views 402 may be as depicted in FIG. 1 and/or FIG. 2.

The calendar client 402 may execute on a mobile device 404. The mobile device 404 may be, for example, a mobile telephone or a cellular telephone. The mobile device 404 may store a plurality of event objects, each event object associated with a calendar.

The mobile device 404 may communicate with a server 408 over a network 406. For example, the network 406 may be a wireless cellular network.

The server 408 may be configured to execute a server client 410. The server client 410 may provide a web-interface to a user's calendars through the Internet. The server calendar client 410 may also synchronize with the handset calendar client 402 to provide the user's calendars to the user 400 on the mobile device 404.

The handset client 402 and the server client 410 may both access copies of calendars and event objects. The event objects may be synchronized between the handset client 402 and the server client 410. The calendars 414 and 416 may each include metadata regarding the calendar, such as a calendar identifier, a calendar color, a calendar name, etc.

It will be appreciated that any number of calendars may exist in the system.

The events objects 418 and 420 may be stored as vCal or iCal objects. The event objects may be transmitted and/or received over the network 406 using SyncML DS protocol. It will be appreciated that any number of event objects may be associated with a calendar.

It will be appreciated that if a handset calendar client 402 is not configured to parse the event objects and determine an associated calendar for each event object, a calendar may still be displayed to the user 400. However, the calendar may lack the color-coding scheme or other scheme indicating the associated calendar of each event.

It will be appreciated that synchronization of the event objects may occur in both directions: from the server to the mobile or consumer device and from the mobile or consumer device to the server. Both the server and the mobile device are configured to format the event objects as iCAL/vCAl and to include the non-standard information discussed above, as well as to extract the non-standard information from the event objects.

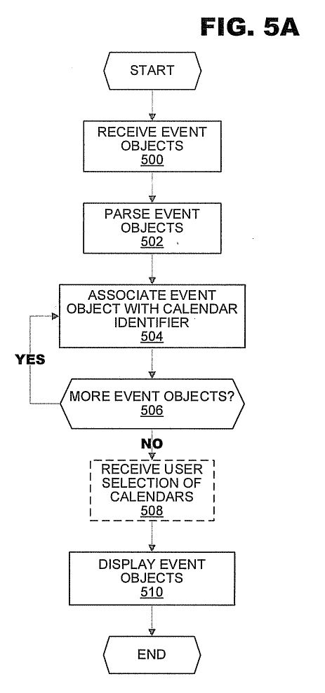

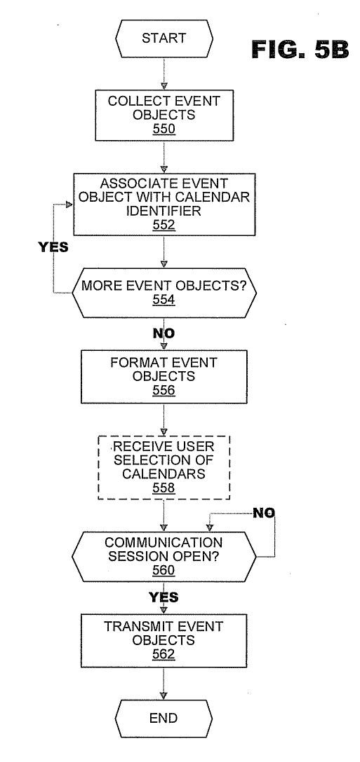

FIG. 5A shows an example procedure for synchronizing multiple calendars with a mobile device and displaying that to the end user in accordance with an embodiment of the present invention. The procedure may execute on a mobile device, as shown, for example, in FIG. 4.

It will be appreciated that the system discussed above is symmetric: a user may create new objects in specific calendars on the server via, e.g., a web interface. The server may format event objects from multiple calendars into iCAL/vCAL and add the calendar identifier, calendar name, calendar color, etc. The server may then transmit the event objects to the mobile or consumer device, and the device may extract calendar identifier, calendar name, calendar color, etc. from the event objects. Similarly, the user may create new event objects in specific calendars on the mobile or consumer device and the event objects will be formatted for transmission to the server, where the calendar identifier, calendar name, calendar color, etc. may be extracted from the event objects by the server.

In 500, a calendar client on the mobile device may receive event objects. The event objects may be as discussed above and stored as vCal or iCal objects. The event objects may be received over a wireless network with SyncML DS protocol. Each event object may be associated with a calendar, and the user may have access to a plurality of calendars.

In 502, the calendar client may parse the event objects. Each event object may include a calendar identifier, a calendar color, and a calendar name. Each event object may further include a start time, a stop time, and a description of the event.

In 504, the mobile device may associate each event object with a calendar identifier parsed in 502. For example, a data structure may be created in the mobile device for each event object, the data structure including the event object and its associated calendar identifier.

In 506, the mobile device may test whether there are more event objects to be processed. If yes, the procedure returns to 504. If no, the procedure proceeds to 508.

In 508, the mobile device may optionally receive user selection of calendars. For example, the user selection of calendars may be received from a screen as depicted in FIG. 2. For example, the user may only wish to view events associated with certain calendars.

In 510, the mobile device may display the event objects. For example, the event objects may be displayed on a calendar client as depicted in FIG. 1.

It will be appreciated that the above procedure may be easily adapted to provide a view of events associated with a plurality of calendars over the Internet via a web-interface, or any other device configured to access the server and display the events.

FIG. 5B depicts a first example procedure for synchronizing multiple calendars to a mobile device in accordance with an embodiment of the present invention. The procedure may execute on a server, as depicted, for example, in FIG. 4.

In 550, the server may collect event objects associated with calendars the user has access to. The user may have access to a calendar stored on the server, other calendars available online, and a calendar stored on his personal computer. Event objects are collected from each calendar by the server. It will be appreciated that filters may be in place to limit the event objects collected. For example, the user may specify that only event objects of the previous three months and all future event objects are collected.

In 552, each event object may be associated with a calendar identifier. The event object may further be associated with a calendar name and a calendar color. For example, the calendar identifier, name, and color may be stored as non-standard information in the event object, which is stored as a vCal or iCal object.

In 554, the procedure tests whether there are more event objects to be processed. If yes, the procedure returns to 552. If no, the procedure proceeds to 556.

In 556, the server may format event objects. For example, if the event objects are not in vCal or iCal format, the server may convert them into a proper format. Calendar metadata may be inserted into the event objects as non-standard information.

In 558, the server may optionally receive a user selection of calendars. For example, the user may input a selection of calendars on the mobile device specifying that only event objects associated with selected calendars are to be synchronized. This may reduce bandwidth requirements in synchronizing the calendars.

In 560, the server may test whether a communication session is open with the mobile device. If yes, the server may proceed to 562. If no, the server may either wait for a connection to open or retry opening a connection to the mobile device. The connection may be made over the wireless network and be configured to transmit and/or receive the event objects via SynchML DS protocol.

In 562, the server may transmit the event objects to the mobile device. The server may also receive modified or new event objects from the mobile device, if the user had modified or created new event objects at the mobile device.

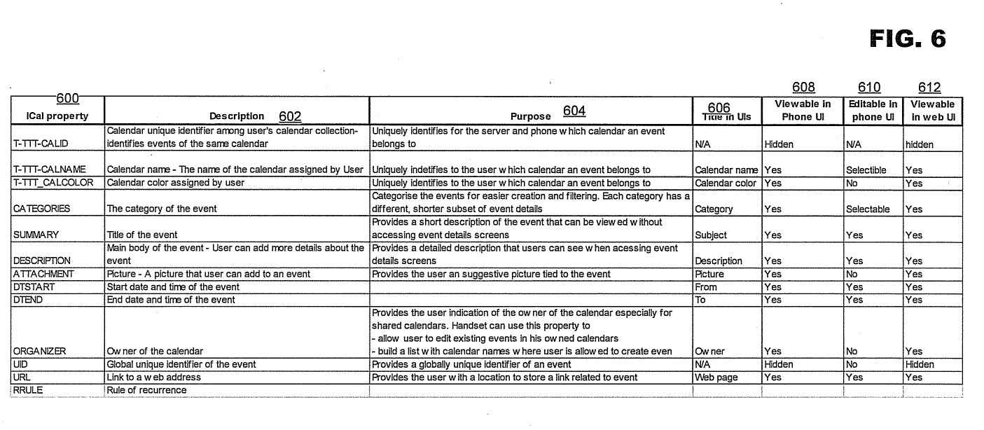

FIG. 6 shows example data fields to allow synchronizing multiple calendars with a mobile device in accordance with an embodiment of the present invention. Data fields may be added as non-standard information to event objects, which may be stored as iCal or vCal objects as discussed above. Data fields may also be existing fields within the iCal or vCal format. The data fields may be added to the event objects by either client when retrieving the event objects from their associated calendars. The data fields may be parsed by the calendar client to determine each event object's associated calendar and other information. The data fields may be used in event objects as depicted in FIG. 4.

A plurality of iCal properties 600 may be added to an event object. The properties 600 may be associated with descriptions 602. The properties 600 may have the purposes depicted in purposes 604. The properties 600 may have titles 606 in the user interface. Note that UI refers to user interface, and UIs refers to user interfaces. The properties 600 may be viewable or not viewable in a mobile device user interface 608. The properties 600 may be editable or not editable in a mobile device user interface 610. The properties 600 may be viewable or not viewable in a web interface 610.

Non-standard information stored in the event object may include a calendar identifier, a calendar name, and a calendar color.

A calendar identifier may identify a calendar among the user's calendar collection. The calendar identifier may be used in an event object to identify the calendar with which it is associated.

A calendar name may store a name of the calendar, selected by the user or system. The calendar name may describe the calendar for user reference, for example, “school” “work”, “soccer team” “personal” etc.

A calendar color may store a user-selected color assigned to the calendar. For example, all event objects displayed as discussed above may be displayed in the calendar color. This color-coding of event objects according to their associated calendar may improve usability of a user's events from multiple calendars.

A category field may store a category of the event. A summary field may store the title of the event object. A description field may store a description of the event object. An attachment field may allow a user to add a picture associated with the event object. A dtstart field may store a start date and time of the event object. A dtend field may store an end date and time of the event object. An organizer field may store the owner of the calendar associated with the event object. A UID field may store a global unique identifier of the event object and identify the event object from all other event objects. A URL field may store a web address associated with the event object. An rrule field may store a recurrence rule associated with the event object.

It will be appreciated that other columns may be added to provide additional functionality or description to properties 600. It will be appreciated that additional data fields may be added to event objects in the system to extend functionality beyond color-coding or otherwise indicating an associated calendar of an event object.

Other transmission protocols may be used instead of or in addition to SyncML DS. Further other similar functionality may be added to other objects by adding non-standard information within the object for transmission. The non-standard information may be extracted by a receiver and utilized.

One example embodiment of the present invention may be a method for synchronizing a plurality of calendars on a mobile or other device. The method may include responsive to receiving a plurality of event objects, parsing each event object into event information and a calendar identifier. The method may include associating each event object with a calendar based on the calendar identifier. The method may include displaying the event objects on a calendar client executing on the mobile device, wherein each event object indicates the calendar with which it is associated. The mobile device may be a cellular phone. The event objects may be received or sent with a SyncML DS protocol. The event objects may be vCal or iCal objects. Each event object may include a calendar name and a calendar color. Each displayed event object may be color-coded according to the associated calendar color. The method may include, responsive to a user selection of calendars to display, displaying event objects associated with the user-selected calendars.

Another example embodiment of the present invention may be a method for synchronizing a plurality of calendars on a mobile device. The method may include collecting event objects, each event object associated with a calendar. The method may include associating each event object with a calendar identifier corresponding to its associated calendar. The method may include formatting each event object for transmission to the mobile device. The method may include responsive to securing a communication session with the mobile device, transmitting the event objects. The mobile device may be a cellular phone. The event objects may be transmitted and/or received with a SyncML DS protocol. The event objects may be vCal or iCal objects. Each event object may include a calendar name and a calendar color corresponding to its associated calendar. Each event object may be color-coded according to the associated calendar color when displayed on the mobile device. The method may include responsive to a user selection of calendars, only transmitting and/or receiving the event objects associated with the user-selected calendars.

Another example embodiment of the present invention may be a system for synchronizing a plurality of calendars on a mobile or other consumer device. The system may include a server, the server accessing a plurality of calendars. The server may be configured to collect event objects associated with each calendar. The server may be configured to associate each event object with a calendar identifier corresponding to its associated calendar. The server may be configured to format each event object for transmission. The system may include a communications link configured to transmit the event objects. The system may include a mobile device configured to receive the event objects over the communications link. The mobile device may be configured to, responsive to receiving the event objects, parse each event object into event information and a calendar identifier. The mobile device may be configured to associate each event object with a calendar based on the calendar identifier. The mobile device may be configured to display the event objects on a calendar client executing on the mobile device, wherein each event object indicates the calendar with which it is associated. The mobile device may be a cellular phone. The event objects may be transmitted and/or received with a SyncML DS protocol. The event objects may be vCal or iCal objects.

Each event object may include a calendar name and a calendar color corresponding to its associated calendar and each event object is color-coded according to the associated calendar color when displayed on the mobile device. The server may be configured to, responsive to a user selection of calendars, only transmitting the event objects associated with the user-selected calendars. The server also may be configured to receive event objects associated with the user-selected calendars.

Embodiments of the present invention further provide a method for synchronizing a plurality of calendars on a mobile device, including: responsive to receiving a plurality of event objects, parsing each event object into event information and a calendar identifier; associating each event object with a calendar based on the calendar identifier; and displaying the event objects on a calendar client executing on the mobile device, wherein each event object indicates the calendar with which it is associated. In further embodiments, the mobile device is a cellular telephone. In further embodiments, the event objects are received with a SyncML DS protocol. In further embodiments, the event objects are vCal or iCal objects. In further embodiments, each event object includes a calendar name, calendar identifier, a calendar color, a category, and/or an organizer. In further embodiments, each displayed event object is color-coded according to the associated calendar color, and displays the category, the organizer and/or the calendar name. In further embodiments, responsive to a user selection of calendars to display, event objects associated with the user-selected calendars are displayed.

Embodiments of the present invention provide a method for synchronizing a plurality of calendars on a mobile device, including collecting event objects, each event object associated with a calendar; associating each event object with a calendar identifier corresponding to its associated calendar; formatting each event object for transmission to the mobile device; and responsive to securing a communication session with the mobile device, transmitting the event objects. The mobile device may be a cellular telephone or other device. The event objects may be transmitted and/or received with a SyncML DS protocol. The event objects may be vCal or iCal objects. Each event object may include a calendar name, calendar identifier, a calendar color, a category, and an organizer. Each event object may be color-coded according to the associated calendar color when displayed on the mobile device, and displays the category, the organizer and the calendar name. Responsive to a user selection of calendars, only the event objects associated with the user-selected calendars may be transmitted.

Embodiments of the present invention provide a system for synchronizing a plurality of calendars on a mobile or other consumer device, including a server, the server accessing a plurality of calendars, the server configured to, collect event objects associated with each calendar, associate each event object with a calendar identifier corresponding to its associated calendar, and format each event object for transmission; a communications link configured to transmit the event objects; and a mobile or other consumer device configured to receive the event objects over the communications link, the device configured to, responsive to receiving the event objects, parse each event object into event information and a calendar identifier, associate each event object with a calendar based on the calendar identifier, and display the event objects on a calendar client executing on the device, wherein each event object indicates the calendar with which it is associated.

In further embodiments, the consumer device is a mobile device which is a cellular telephone. In further embodiments, the event objects are transmitted and/or received with a SyncML DS protocol. In further embodiments, the event objects are vCal objects. In further embodiments, the event objects are iCal objects. In further embodiments, each event object includes a calendar name each event object includes a calendar name, calendar identifier, a calendar color, a category, and an organizer and each event object is color-coded according to the associated calendar color when displayed on the mobile device, and further displayed with its associated category, organizer and calendar name. In further embodiments, the server is further configured to, responsive to a user selection of calendars, only transmitting the event objects associated with the user-selected calendars. In further embodiments, the server is further configured to, responsive to a user selection of calendars, only receiving the event objects associated with the user-selected calendars.

Embodiments of the present invention provide for a computer-readable medium including instructions adapted to execute a method for synchronizing a plurality of calendars on a consumer or mobile device, including collecting event objects, each event object associated with a calendar; associating each event object with a calendar identifier corresponding to its associated calendar; formatting each event object for transmission to the mobile device; and responsive to securing a communication session with the device, transmitting the event objects. The device may be a cellular telephone. The event objects may be transmitted and/or received with a SyncML DS protocol. The event objects may be vCal or iCal objects. Each event object may include a calendar name, calendar identifier, a calendar color, a category, and an organizer. Each event object may be color-coded according to the associated calendar color when displayed on the device, and displays the category, the organizer and the calendar name. Responsive to a user selection of calendars, only the event objects associated with the user-selected calendars may be transmitted and/or received.

It should be understood that there exist implementations of other variations and modifications of the invention and its various aspects, as may be readily apparent, for example, to those of ordinary skill in the art, and that the invention is not limited by specific embodiments described herein. Features and embodiments described above may be combined with each other in different combinations. It is therefore contemplated to cover any and all modifications, variations, combinations or equivalents that fall within the scope of the present invention.

What is claimed is:

1. A method for synchronizing a plurality of calendars on a consumer device, comprising:
responsive to receiving a plurality of event objects, parsing each event object into event information and a calendar identifier;
associating each event object with a calendar based on the calendar identifier; and
displaying the event objects on a calendar client executing on the consumer device,
wherein each event object indicates the calendar with which it is associated.

2. The method of claim 1, wherein the consumer device is at least one of a mobile device and a cellular telephone.

3. The method of claim 1, wherein the event objects are received via a SyncML DS protocol.

4. The method of claim 1, wherein the consumer device communicates with at least one of a backend server and network location having at least one calendar application providing the calendar.

5. The method of claim 1, wherein the event objects are at least one of: vCalendar and iCalendar objects.

6. The method of claim 5, wherein each event object includes a calendar name, a calendar identifier, a calendar color, a category, and an organizer.

7. The method of claim 6, wherein each displayed event object is color-coded according to the associated calendar color, and displays the category, the organizer, and the calendar name.

8. The method of claim 1, further comprising:
responsive to a user selection of calendars to display, displaying event objects associated with the user-selected calendars.

9. A method for synchronizing a plurality of calendars on a consumer device, comprising:
collecting event objects, each event object associated with a respective calendar;
associating each event object with a calendar identifier corresponding to its associated calendar;
formatting each event object for transmission to the consumer device; and
responsive to securing a communication session with the consumer device, transmitting the event objects.

10. The method of claim 9, wherein the consumer device is at least one of a mobile device and a cellular phone.

11. The method of claim 9, wherein the consumer device communicates with at least one of a backend server and a network location having at least one calendar application providing the calendar.

12. The method of claim 9, wherein the event objects are transmitted via a SyncML DS protocol.

13. The method of claim 9, wherein the event objects are at least one of: vCalendar and iCalendar objects.

14. The method of claim 13, wherein each event object includes a calendar name, calendar identifier, a calendar color, a category, and an organizer.

15. The method of claim 14, wherein each event object is color-coded according to the associated calendar color when displayed on the mobile device, and displays the category, the organizer, and the calendar name.

16. The method of claim 9, further comprising:
responsive to a user selection of calendars, only transmitting the event objects associated with the user-selected calendars.

17. A system for synchronizing a plurality of calendars on a consumer device, comprising:
a server, the server accessing a plurality of calendars, the server being configured to:
collect event objects associated with each calendar,
associate each event object with a calendar identifier corresponding to its associated calendar, and
format each event object for transmission;
a communications link for transmitting the event objects; and
a consumer device for receiving the event objects over the communications link, the consumer device being configured to:
responsive to receiving the event objects, parse each event object into event information and a calendar identifier,
associate each event object with a calendar based on the calendar identifier, and
display the event objects on a calendar client executing on the consumer device, wherein each event object indicates the calendar with which it is associated.

18. The system of claim 17, wherein the consumer device is at least one of a mobile device and a cellular phone.

19. The system of claim 17, wherein the consumer device communicates with at least one of a backend server and a network location having at least one calendar application providing the calendar.

20. The system of claim 17, wherein the event objects are transmitted via SyncML DS protocol.

21. The system of claim 17, wherein the event objects are at least one of: vCalendar and iCalendar objects.

22. The system of claim 21, wherein each event object includes a calendar name, calendar identifier, a calendar color, a category, and an organizer, and each event object is color-coded according to the associated calendar color when displayed on the consumer device, and further displayed with its associated category, organizer and calendar name.

23. The system of claim 17, wherein the server is configured to, responsive to a user selection of calendars, only transmitting the event objects associated with the user-selected calendars.
